(19) United States
(12) Patent Application Publication
(10) Pub. No.: US 2011/0164685 A1
(43) Pub. Date: Jul. 7, 2011

(54) ENTROPY DECODER WITH ENTROPY DECODING INTERFACE AND METHODS FOR USE THEREWITH

(75) Inventors: Jing Zhang, Richmond Hill (CA); Lewis Leung, Markham (CA)

(73) Assignee: VIXS SYSTEMS, INC., Toronto (CA)

(21) Appl. No.: 12/651,986

(22) Filed: Jan. 4, 2010

(51) Int. Cl. H04N 7/26

(52) U.S. Cl. 375/240.24; 375/E07.027

(57) ABSTRACT

An entropy decoding module can be used in a video decoder that decodes a stream of video data from a first buffer. An entropy decoding interface includes a second buffer. A load controller automatically fetches the video data from the first buffer for storage in the second buffer. A search engine searches the video data stored in the second buffer for at least one bit pattern. A processing module retrieves the video data from the second buffer for entropy decoding.

### TECHNICAL FIELD OF THE INVENTION

The present invention relates to entropy decoding used in devices such as video decoders/codecs.

### DESCRIPTION OF RELATED ART

Video encoding has become an important issue for modern video processing devices. Robust encoding algorithms allow video signals to be transmitted with reduced bandwidth and stored in less memory. However, the accuracy of these encoding methods face the scrutiny of users that are becoming accustomed to greater resolution and higher picture quality. Standards have been promulgated for many encoding methods including Motion Picture Experts Group (MPEG) format (such as MPEG1, MPEG2 or MPEG4), Quicktime format, Real Media format, Windows Media Video (WMV) or Audio Video Interleave (AVI) and the H.264 standard that is also referred to as MPEG-4, part 10 or Advanced Video Coding, (AVC).

Video coding methods typically include entropy coding such as Huffman coding, arithmetic coding, or context-based adaptive binary arithmetic coding (CABAC), etc. These coding techniques typically employ variable-length codes that create a binary stream. Efficient entropy decoding is important to the speed and accuracy of a video decoder. In particular, the variable-length nature of typical entropy codes can create inefficiencies in decoders implemented via processors that operate on fixed-length operands.

A general-purpose central processing unit (CPU) cache architecture is suitable for processing program variables where data volume is relatively low, the accessing order is relatively random, life spans of the variables are relatively long and variables can be used multiple times once fetched into the cache memory. In contrast however, video data can be large-sized, consecutive and “short-lived”. In order to process this type of data, a general CPU can map the video data into a cached region/mode and invalidate the cache frequently to update video data. However large volumes of video data will contend for cache memory that can be otherwise used for other purposes. This can also result in more frequent cache miss (for both video and non-video data), and make cache management non-transparent for the program. Another approach is to map the video data into non-cached region and load a minimum amount of video data (normally one byte, word or dword) when needed. This approach can not make effective use of the memory system bandwidth which prefers transfers of large size, and can cause intrinsic throughput limits. Further, modern memory systems (e.g. DDR2/DDR3) tend to have large access latency which could be exacerbated by the large number of clients in video processing systems. This will result in bigger cache miss penalty and longer load latency (corresponding to the approaches mentioned above) and make the system performance even worse. Video decoding throughput can be memory access latency limited.

Further limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIGS. 1-3 present pictorial diagram representations of various devices in accordance with embodiments of the present invention.

FIG. 4 presents a block diagram representation of a video processing device in accordance with an embodiment of the present invention.

FIG. 5 presents a block diagram representation of an video encoder/decoder 102 in accordance with an embodiment of the present invention.

FIG. 6 presents a block flow diagram of a video encoding operation in accordance with an embodiment of the present invention.

FIG. 7 presents a block flow diagram of a video decoding operation in accordance with an embodiment of the present invention.

FIG. 8 presents a block diagram representation of an entropy decoding module 75 in accordance with an embodiment of the present invention.

FIG. 9 presents a graphical representation of buffers 300 and 310 in accordance with an embodiment of the present invention.

FIG. 10 presents a flowchart representation of a method in accordance with an embodiment of the present invention.

FIG. 11 presents a block diagram representation of a video distribution system 375 in accordance with an embodiment of the present invention.

FIG. 12 presents a block diagram representation of a video storage system 179 in accordance with an embodiment of the present invention.

### DETAILED DESCRIPTION OF THE INVENTION INCLUDING THE PRESENTLY PREFERRED EMBODIMENTS

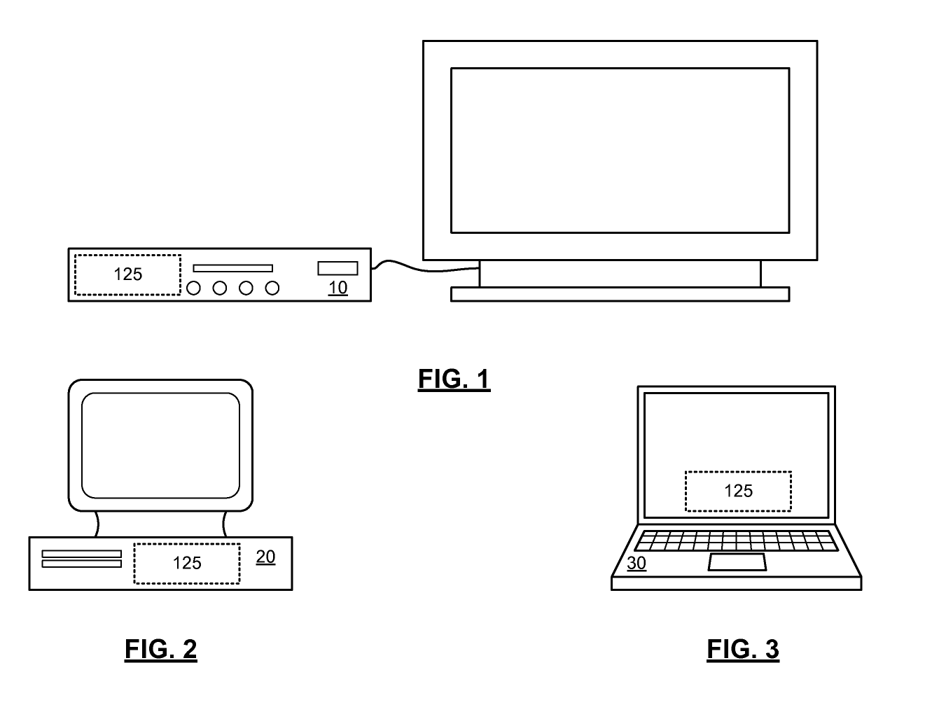

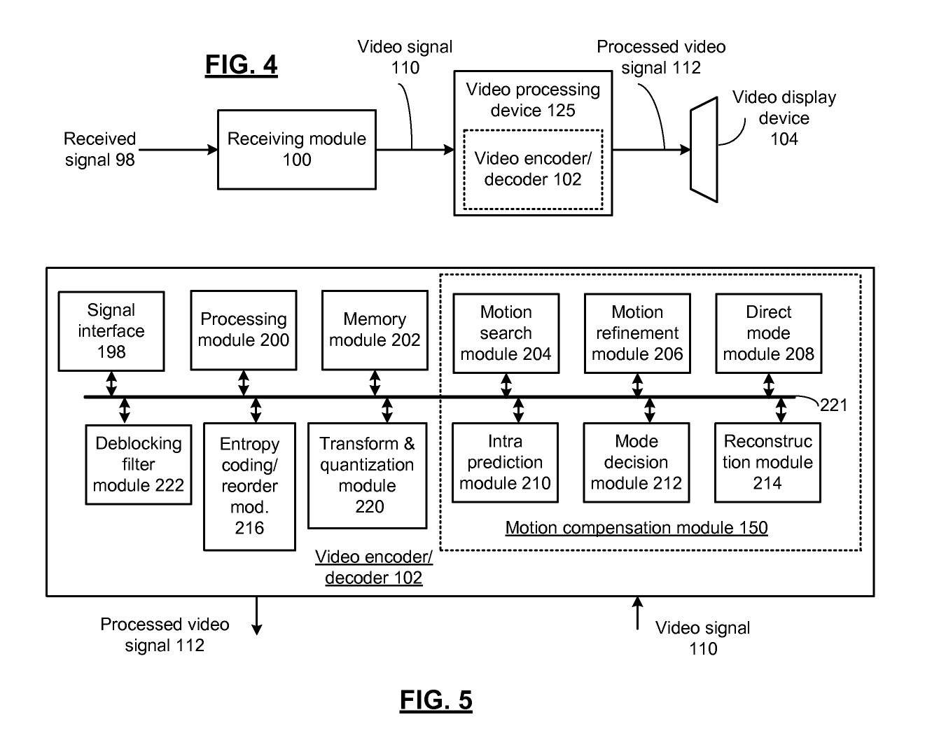

FIGS. 1-3 present pictorial diagram representations of a various video processing devices in accordance with embodiments of the present invention. In particular, set top box 10 with built-in digital video recorder functionality or a stand alone digital video recorder, computer 20 and portable computer 30 illustrate electronic devices that incorporate a video processing device 125 that includes one or more features or functions of the present invention. While these particular devices are illustrated, video processing device 125 includes any device that is capable of decoding video content in accordance with the methods and systems described in conjunction with FIGS. 4-12 and the appended claims.

FIG. 4 presents a block diagram representation of a video processing device 125 in accordance with an embodiment of the present invention. In particular, video processing device 125 operates in conjunction with a receiving module 100, such as a television receiver, cable television receiver, satellite broadcast receiver, broadband modem, 3G transceiver or other information receiver or transceiver that is capable of receiving a received signal 98 and extracting one or more video signals 110 via time division demultiplexing, frequency division demultiplexing or other demultiplexing technique. Video encoder/decoder module 102 is coupled to the receiving module 100 to decode, re-encode and/or transcode the video signal 110 to create processed video signal 112 in a format corresponding to video display device 104. Processed video signal 112 can be a composite video signal, s-video signal, component video signal, high-definition multimedia interface (HDMI) signal, video graphics array (VGA) signal or other signal in either analog or digital format. While shown as a separate device, receiving module can be included as a portion of video processing device 125.

In an embodiment of the present invention, the received signal 98 is a broadcast video signal, such as a television signal, high definition television signal, enhanced high definition television signal or other digital video signal that has been transmitted over a wireless medium, either directly or through one or more satellites or other relay stations or through a cable network, optical network or other transmission network. In addition, received signal 98 can be generated from a stored video file, played back from a recording medium such as a magnetic tape, magnetic disk or optical disk, and can include a streaming video signal that is transmitted over a public or private network such as a local area network, wide area network, metropolitan area network or the Internet.

Video signal 110 can include a digital video signal that has been encoded in accordance with a digital video codec standard such as H.264, MPEG-4 Part 10 Advanced Video Coding (AVC) or other digital format such as a Motion Picture Experts Group (MPEG) format (such as MPEG1, MPEG2 or MPEG4), Quicktime format, Real Media format, Windows Media Video (WMV) or Audio Video Interleave (AVI), or another digital video format, either standard or proprietary.

Video display devices 104 can include a television, monitor, computer, handheld device or other video display device that creates an optical image stream either directly or indirectly, such as by projection, based on decoding the video signal 110 either as a streaming video signal or by playback of a stored digital video file. It is noted that the present invention can also be implemented by transcoding a video stream and storing it or decoding a video stream and storing it, for example, for later playback on a video display device.

Video encoder/decoder 102 includes an entropy decoding module that operates in accordance with the present invention and, in particular, includes many optional functions and features described in conjunction with FIGS. 5-12 that follow.

FIG. 5 presents a block diagram representation of a video encoder/decoder 102 in accordance with an embodiment of the present invention. Video encoder/decoder 102 can be a video codec that operates in accordance with many of the functions and features of the H.264 standard, the MPEG-4 standard, VC-1 (SMPTE standard 421M) or other standard, to generate processed video signal 112 by encoding, decoding or transcoding video input signal 110. Video input signal 110 is optionally formatted by signal interface 198 for encoding, decoding or transcoding by video encoder/decoder 102. In particular, video encoder/decoder 102 includes an entropy decoding module used in implementing entropy coding/reorder module 216.

The video encoder/decoder 102 includes a processing module 200 that can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory module 202. Memory module 202 may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing module 200 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

Processing module 200, and memory module 202 are coupled, via bus 221, to the signal interface 198 and a plurality of other modules, such as motion search module 204, motion refinement module 206, direct mode module 208, intra-prediction module 210, mode decision module 212, reconstruction module 214, entropy coding/reorder module 216, forward transform and quantization module 220 and deblocking filter module 222. The modules of video encoder/decoder 102 can be implemented in software, firmware or hardware, depending on the particular implementation of processing module 200. It should also be noted that the software implementations of the present invention can be stored on a tangible storage medium such as a magnetic or optical disk, read-only memory or random access memory and also be produced as an article of manufacture. While a particular bus architecture is shown, alternative architectures using direct connectivity between one or more modules and/or additional buses can likewise be implemented in accordance with the present invention.

Video encoder/decoder 102 can operate in various modes of operation that include an encoding mode and a decoding mode that is set by the value of a mode selection signal that may be a user defined parameter, user input, register value, memory value or other signal. In addition, in video encoder/decoder 102, the particular standard used by the encoding or decoding mode to encode or decode the input signal can be determined by a standard selection signal that also may be a user defined parameter, user input, register value, memory value or other signal. In an embodiment of the present invention, the operation of the encoding mode utilizes a plurality of modules that each perform a specific encoding function. The operation of decoding can also utilizes at least one of these plurality of modules to perform a similar function in decoding. In this fashion, modules such as the motion refinement module 206, direct mode module 208, and intra-prediction module 210, mode decision module 212, reconstruction module 214, transformation and quantization module 220, and deblocking filter module 222, can be used in both the encoding and decoding process to save on architectural real estate when video encoder/decoder 102 is implemented on an integrated circuit or to achieve other efficiencies.

While not expressly shown, video encoder/decoder 102 can include a comb filter or other video filter, and/or other module to support the encoding of video input signal 110 into processed video signal 112.

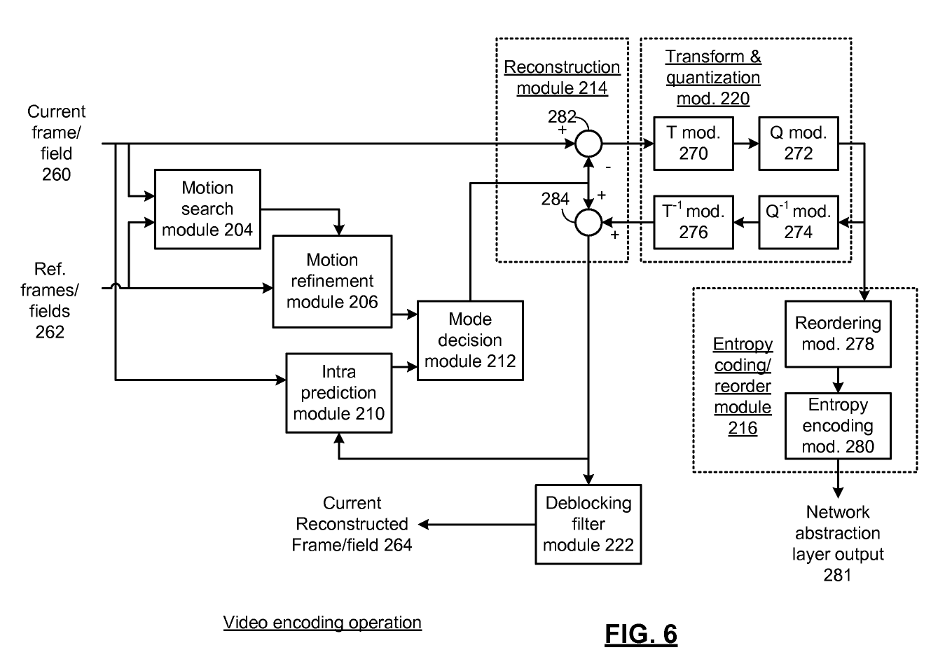

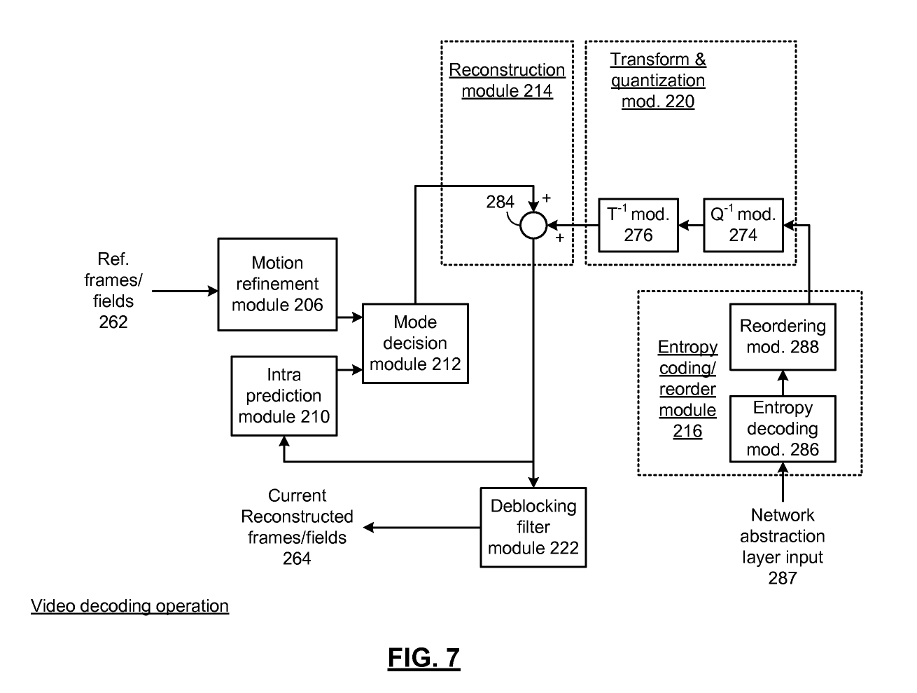

Further details of specific encoding and decoding processes that use these function specific modules will be described in greater detail in conjunction with FIGS. 6 and 7.

FIG. 6 presents a block flow diagram of a video encoding operation in accordance with an embodiment of the present invention. In particular, an example video encoding operation is shown that uses many of the function specific modules described in conjunction with FIG. 5 to implement a similar encoding operation. Motion search module 204 generates a motion search motion vector for each macroblock of a plurality of macroblocks based on a current frame/field 260 and one or more reference frames/fields 262. Motion refinement module 206 generates a refined motion vector for each macroblock of the plurality of macroblocks, based on the motion search motion vector. Intra-prediction module 210 evaluates and chooses a best intra prediction mode for each macroblock of the plurality of macroblocks. Mode decision module 212 determines a final motion vector for each macroblock of the plurality of macroblocks based on costs associated with the refined motion vector, and the best intra prediction mode.

Reconstruction module 214 generates residual pixel values corresponding to the final motion vector for each macroblock of the plurality of macroblocks by subtraction from the pixel values of the current frame/field 260 by difference circuit 282 and generates unfiltered reconstructed frames/fields by re-adding residual pixel values (processed through transform and quantization module 220) using adding circuit 284. The transform and quantization module 220 transforms and quantizes the residual pixel values in transform module 270 and quantization module 272 and re-forms residual pixel values by inverse transforming and dequantization in inverse transform module 276 and dequantization module 274. In addition, the quantized and transformed residual pixel values are reordered by reordering module 278 and entropy encoded by entropy encoding module 280 of entropy coding/reordering module 216 to form network abstraction layer output 281.

Deblocking filter module 222 forms the current reconstructed frames/fields 264 from the unfiltered reconstructed frames/fields. While a deblocking filter is shown, other filter modules such as comb filters or other filter configurations can likewise be used within the broad scope of the present invention. It should also be noted that current reconstructed frames/fields 264 can be buffered to generate reference frames/fields 262 for future current frames/fields 260.

As discussed in conjunction with FIG. 5, one of more of the modules described herein can also be used in the decoding process as will be described further in conjunction with FIG. 7.

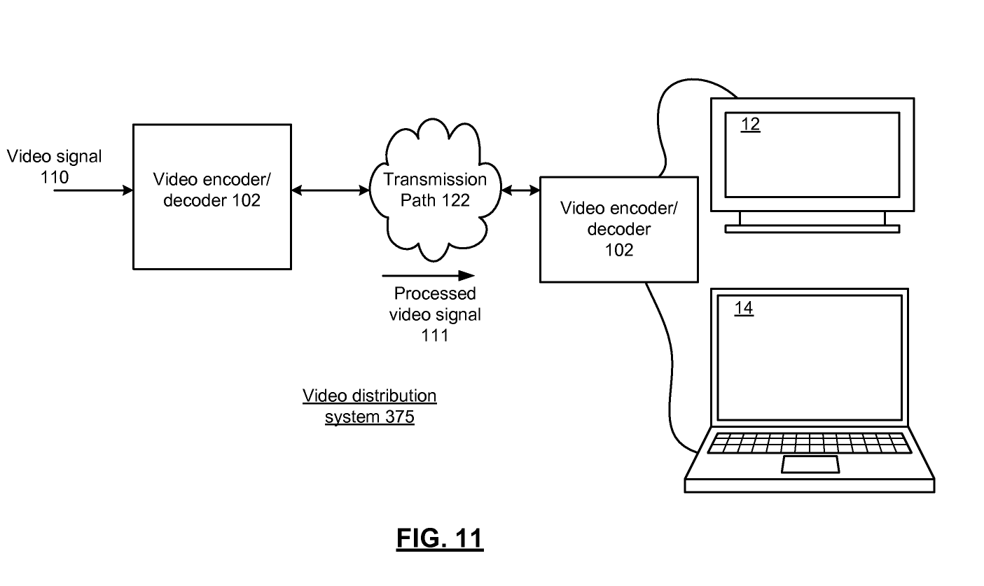

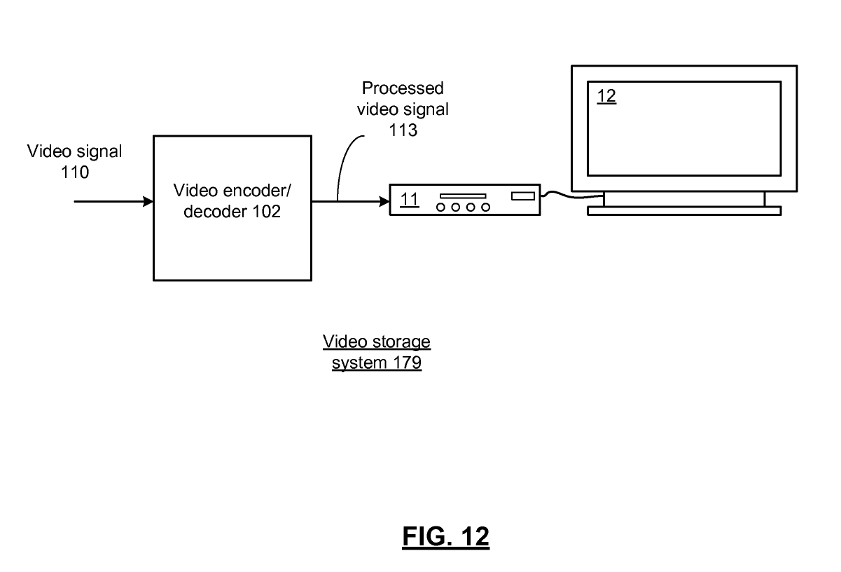

FIG. 7 presents a block flow diagram of a video decoding operation in accordance with an embodiment of the present invention. In particular, this video decoding operation contains many common elements described in conjunction with FIG. 6 that are referred to by common reference numerals. In this case, the motion refinement module 206, the intra-prediction module 210, the mode decision module 212, and the deblocking filter module 222 are each used as described in conjunction with FIG. 11 to process reference frames/fields 262. In addition, the reconstruction module 214 reuses the adding circuit 284 and the transform and quantization module reuses the inverse transform module 276 and the inverse quantization module 274. In should be noted that while entropy coding/reorder module 216 is reused, instead of reordering module 278 and entropy encoding module 280 producing the network abstraction layer output 281, network abstraction layer input 287 is processed by entropy decoding module 286, and reordering module 288.

While the reuse of modules, such as particular function specific hardware engines, has been described in conjunction with the specific encoding and decoding operations of FIGS. 6 and 7, the present invention can likewise be similarly employed to the other embodiments of the present invention and/or with other function specific modules used in conjunction with video encoding and/or decoding.

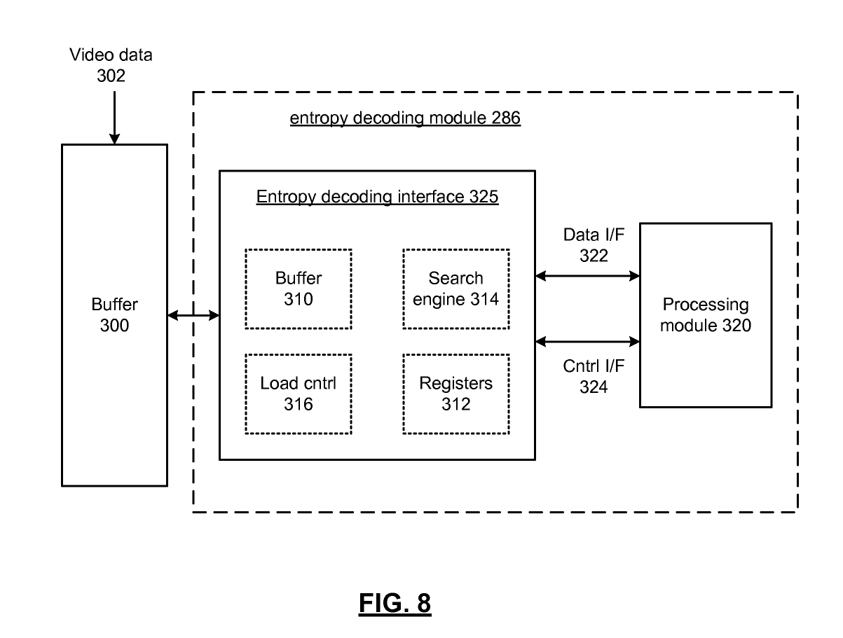

FIG. 8 presents a block diagram representation of an entropy decoding module 286 in accordance with an embodiment of the present invention. In particular, entropy decoding module 286 includes entropy decoding interface 325 that interfaces processing module 320 to a buffer 300. Buffer 300 buffers a stream of video data 302 such as video signal 100, network abstraction layer output 281 or other entropy encoded video data. The buffer 300 can be a ring buffer implemented in a frame buffer or other buffer, cache or memory.

Entropy decoding interface 325 includes a buffer 310 and a load controller 316 that automatically fetches blocks of video data 302 from the buffer 300 for storage in the buffer 310. In an embodiment of the present invention, the entropy decoding interface 325 resides in the input/output (I/O) space of processing module 320, but closely attached to the processing module 320 to minimize access latency and provide fast access to the video data 302. By buffering a local copy of the “head” portion of the video data 302, this data can be quickly accessed by the processing module 320 as if it were accessing a very quick I/O device. As the video data 302 in buffer 310 is consumed, the content of the buffer 310 is updated by fetching more video data 302 from the buffer 300.

Processing module 320 retrieves the video data from the buffer 310 for entropy decoding. Processing module 320 can be a shared processor such as processing module 200 or other shared processing device. In the alternative, processing module can be dedicated processing device such as a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals based on operational instructions that are stored in a memory. The use of a general purpose and/or programmable device for processing module 320 allows the implementation of different decoding algorithms, based on the particular format of video stream 302.

Processing module 320 retrieves the video data from the buffer 310 based an access request that specifies the access size. In particular, data interface 322 allows the processing module to specify an access size with one-bit granularity. For instance, data interface 322 uses different access addresses to represent different access size requests. (e.g. address 1 returns one bit of data, address 2 returns two bits of data, etc.) Entropy decoding interface 325 advances the read pointer in buffer 310 on a bit-by-bit basis to reflect only those bits that have been read by processing module 320. In this fashion, processing module 320 can access code words of video data 302 at an arbitrary bit boundary. This can avoid additional shift operations of processing module 320 that would otherwise be needed for manipulating the video data 302.

In an embodiment of the present invention, the buffer 310 includes a memory interface that analyzes and fulfills each access request from processing module 320. In particular, the memory interface is capable of identifying exception events, and returning pre-configured values to the processing module 320 when an exception event is identified. An example exception event can be triggered when an access request spans video data 302 not loaded in the buffer 310, for instance, when there is no data available, or when all or part of the data requested has not yet been fetched. The pre-configured value or values returned by the entropy decoding interface 325, via either control interface 324 or data interface 322 can indicate the exception and the type of exception to the processing module 320. This can reduce the need for a status check of the buffer 310 prior to each access request. Other exception events of different types can be implemented in a similar fashion.

Rapidly locating a piece of data with known pattern inside video data 302 can accelerate the entropy decoding performed by processing module 320. Entropy decoding interface 325 further includes a search engine 314 that acts as an agent of processing module 320 to search the video data 302 stored in the buffer 310 for one or more bit patterns of interest to the entropy decoding process. In an embodiment of the present invention, search engine 314 is implemented via a state machine, logic circuit, special purpose processing circuit or other hardware that searches the buffered data to quickly locate a pattern. In operation, processing module 320 loads one or more registers 312 of entropy decoding interface 325 with a bit pattern or patterns to be found. In addition, processing module 320 loads one or more registers 312 with one or more search region boundaries, such as an end of search address. The search engine 314 operates to “slide” through the fetched video data 302 in buffer 310, bit by bit, or byte by byte, to find a match. Locations of matching portions of video data 302 are returned to processing module 320 via control interface 324.

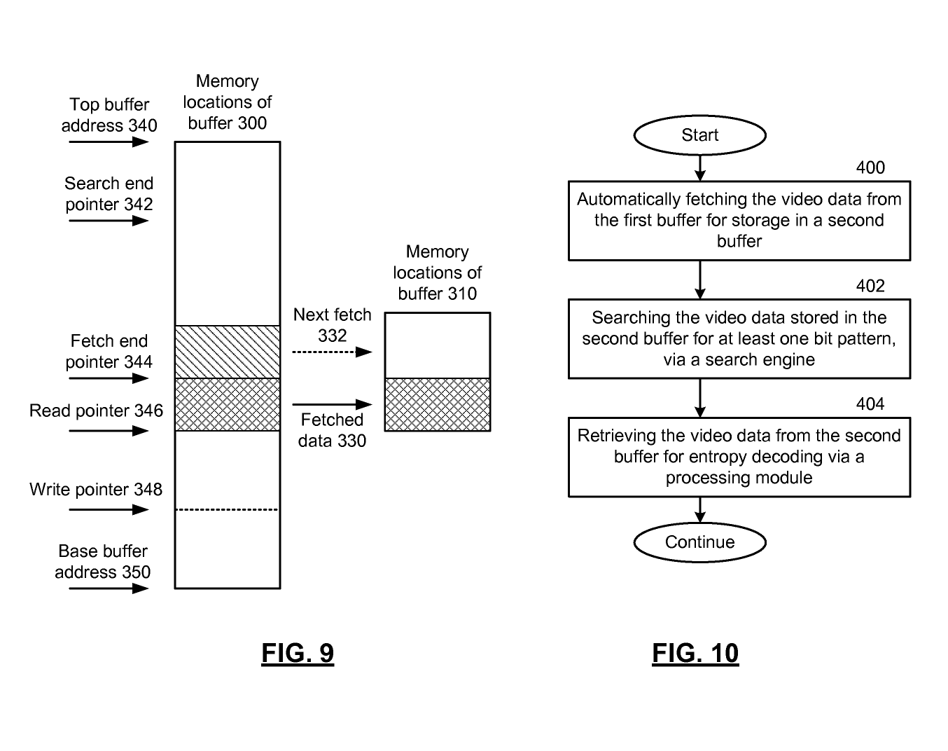

FIG. 9 presents a graphical representation of buffers 300 and 310 in accordance with an embodiment of the present invention. In the example shown, the video data 302 is stored in buffer 300 between top buffer address 340 and base buffer address 350. As discussed in conjunction with FIG. 6, buffer 300 can correspond to a ring buffer portion of a main storage, such as a frame buffer or other memory. Video data 302 is written into buffer 300 based on write pointer 348 that is updated as new data is written. The read pointer 346 and write pointer 348 define the “head” and “tail” of the video data 302 inside the buffer 300. The processing module 320 can designate the initial position of read pointer 346 and the load controller 316 can thereafter update the read pointer 346 as blocks of data are fetched. The write pointer 348 can be initiated by processing module 320 and updated by software once the content inside buffer 300 is updated.

Load controller 316 also maintains a fetch end pointer 344 that designates an ending address in buffer 300. The read pointer 346 and fetch end pointer 344 correspond to blocks of data, such as fetched data 330, that are read for storage into buffer 310. Read pointer 346 and fetch end pointer 344 are updated when a next block of data 332 is fetched. Load controller 316 automatically fetches blocks of video data 302 from buffer 300 into the buffer 310. The load controller 316 loads video data 302 in large blocks, according to the amount of available free space and data consumption speed, to promote efficient memory bandwidth utilization. Load controller 316 strives to reduce the number of requests and yet maintain video data 302 availability to the processing module 320.

As discussed in conjunction with FIG. 6, registers 312 can maintain a search end pointer 342 which, together with read pointer 346, constrains the search region of search engine 314. In an example of operation, processor 320 configures the search range of the buffer 300, and certain key words to be searched by storing a value corresponding to the search end pointer 342 and the bit patterns associated with the key words in registers 312. The processing module 320 triggers the load controller 316 to fetch video data 302 from the buffer 300 into the buffer 310. The search engine 314 slides through the fetched data 330 looking for the key words. Once the key word is found, the control can be taken over by processing module, and it will start retrieving arbitrary size of data from the stream very quickly by accessing the corresponding locations in buffer 310.

FIG. 10 presents a flowchart representation of a method in accordance with an embodiment of the present invention. In particular, a method is presented for use in conjunction with one or more functions and features described in conjunction with FIGS. 1-9. In step 400 the video data is automatically fetched from a first buffer for storage in a second buffer. In step 402, the video data stored in the second buffer is searched for at least one bit pattern via a search engine. In step 404, the video data is retrieved from the second buffer for entropy decoding via a processing module.

In an embodiment of the present invention, the at least one bit pattern includes a plurality of bit patterns and the method further includes loading the plurality of bit patterns from the processing module into a plurality of registers of the search engine. Step 404 can include generating an access request that specifies access size, via the processing module. The access size can have one-bit granularity.

FIG. 11 presents a block diagram representation of a video distribution system 375 in accordance with an embodiment of the present invention. In particular, a processed video signal 111, created by encoding or transcoding a video signal 110, is transmitted from a first video encoder/decoder 102 via a transmission path 122 to a second video encoder/decoder 102 that operates as a decoder. The second video encoder/decoder 102 operates to decode the processed video signal 111 for display on a display device such as television 10, computer 20 or other display device.

The transmission path 122 can include a wireless path that operates in accordance with a wireless local area network protocol such as an 802.11 protocol, a WIMAX protocol, a Bluetooth protocol, etc. Further, the transmission path can include a wired path that operates in accordance with a wired protocol such as a Universal Serial Bus protocol, an Ethernet protocol or other high speed protocol.

FIG. 12 presents a block diagram representation of a video storage system 179 in accordance with an embodiment of the present invention. In particular, device 11 is a set top box with built-in digital video recorder functionality, a stand alone digital video recorder, a DVD recorder/player or other device that stores a processed video signal 113 for display on video display device such as television 12. While video encoder/decoder 102 is shown as a separate device, it can further be incorporated into device 11. In this configuration, video encoder/decoder 102 can further operate to decode the processed video signal 113 when retrieved from storage to generate a video signal in a format that is suitable for display by video display device 12. While these particular devices are illustrated, video storage system 179 can include a hard drive, flash memory device, computer, DVD burner, or any other device that is capable of generating, storing, decoding and/or displaying the video content of processed video signal 113 in accordance with the methods and systems described in conjunction with the features and functions of the present invention as described herein.

In preferred embodiments, the various circuit components are implemented using 0.35 micron or smaller CMOS technology. Provided however that other circuit technologies, both integrated or non-integrated, may be used within the broad scope of the present invention.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As the term module is used in the description of the various embodiments of the present invention, a module includes a functional block that is implemented in hardware, software, and/or firmware that performs one or module functions such as the processing of an input signal to produce an output signal. As used herein, a module may contain submodules that themselves are modules.

Thus, there has been described herein an apparatus and method, as well as several embodiments including a preferred embodiment, for implementing a video processing device, video decoder and an entropy decoder for use therewith. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. An entropy decoding module for use in a video decoder that decodes a stream of video data from a first buffer, the entropy decoding module comprising:
an entropy decoding interface, coupled to the first buffer, that includes:
a second buffer;
a load controller, coupled to the second buffer, that automatically fetches blocks of video data from the first buffer for storage in the second buffer; and
a search engine, coupled to the second buffer, that searches the video data stored in the second buffer for at least one bit pattern; and
a processing module, coupled to the entropy decoding interface, that retrieves the video data from the second buffer for entropy decoding.

2. The entropy decoding module of claim 1 wherein the search engine includes at least one register that stores the at least one bit pattern.

3. The entropy decoding module of claim 1 wherein the at least one bit pattern includes a plurality of bit patterns and the search engine includes a plurality of registers for storing the plurality of bit patterns.

4. The entropy decoding module of claim 3 wherein the plurality of bit patterns are established by the processing module.

5. The entropy decoding module of claim 1 wherein the search engine searches the stream of video data within a search region bounded by a search end pointer.

6. The entropy decoding module of claim 1 wherein the first buffer includes a read pointer that is maintained by the load controller.

7. The entropy decoding module of claim 1 wherein the processing module retrieves the video data from the second buffer based an access request that specifies access size.

8. The entropy decoding module of claim 7 wherein the access size has one-bit granularity.

9. The entropy decoding module of claim 7 wherein the entropy decoding interface analyzes the access request to identify at least one exception event, and returns a pre-configured value to the processing module when the at least one exception event is identified.

10. The entropy decoding module of claim 9 wherein the at least one exception event includes an access request that spans video data not loaded in the second buffer.

11. A method for use in entropy decoding of a stream of video data from a first buffer, the method comprising:
automatically fetching the video data from the first buffer for storage in a second buffer; and
searching the video data stored in the second buffer for at least one bit pattern via a search engine; and
retrieving the video data from the second buffer for entropy decoding via a processing module.

12. The method of claim 11 wherein the at least one bit pattern includes a plurality of bit patterns and the method further comprises:
loading the plurality of bit patterns in a plurality of registers of the search engine.

13. The method of claim 12 wherein the plurality of bit patterns are loaded from the processing module.

14. The method of claim 11 wherein retrieving the video data from the second buffer includes generating an access request that specifies access size, via the processing module.

15. The method of claim 14 wherein the access size has one-bit granularity.
